(19) United States
(12) Patent Application Publication
(10) Pub. No.: US 2002/0182391 A1
(43) Pub. Date: Dec. 5, 2002

(54) Multilayer matte films

(76) Inventors: Robert A. Migliorini, North Haven, CT (US); Salvatore J. Pellingra, Wolcott, NY (US); Karen A. Sheppard, Victor, NY (US)

Correspondence Address: ExxonMobil Chemical Company, P.O. Box 2149, Baytown, TX, 77522, US

(21) Appl. No.: 09/826,338

(22) Filed: Apr. 4, 2001

(51) Int. Cl. B32B 7/02; B32B 27/08

(52) U.S. Cl. 428/216; 428/327; 428/328; 428/330; 428/331; 428/518; 428/520

(57) ABSTRACT

A multilayer matte film is described. The film has a core layer and one or more matte layers on its surfaces. Additionally, each one or more matte layers may have a skin layer or layers contiguous to the matte layer. Use in packaging, labeling or imaging is contemplated.

### TECHNICAL FIELD

This invention relates generally to multilayer films containing materials that render the film matte in appearance, having relatively high haze. More specifically this matte film may have a skin layer over the matte layer.

### BACKGROUND

Matte films, films with a relatively high haze, are commercially useful in packaging, labeling and imaging uses. The general utility of such films is that they do not have high clarity, a feature sometimes desirable in such uses.

Prior production of hazy films, including multilayer films, may have been accomplished using single polymers known for their haziness, or polymer blends. Such materials often provide processing liabilities to a film manufacturer, such as die lip buildup, die drool, film tear-offs and the like. In multilayer films such matte layers are used on the surface.

U.S. Pat. No. 5,366,796 suggests a multilayer film, which purportedly has a high haze, a minimum gloss, and a uniform mattness of at least one surface. The biaxial oriented multilayer film comprising a) a base layer containing a propylene polymer, b) at least one outer layer containing two components (A) and (B), wherein component A is composed of a high density polyethylene (HDPE), and wherein component (B) is composed of at least one copolymer selected from the group consisting of: ethylene and propylene, ethylene and butylene, propylene and butylene, ethylene and an α-olefin containing 5 to 10 carbon atoms, and propylene and an α-olefin containing 5 to 10 carbon atoms, c) wherein the film has a haze value, measured by ASTM D1003, of greater than 40, and d) wherein the film has a gloss, measured by ASTM D523-78 of less than 35 at an angle of 85° .

U.S. Pat. No. 5,474,820 suggests at least one outer layer of the multilayer film according to the invention contains a mixture, of two components I and II and, if desired, additives.

Mixture component I of the outer layer mixture essentially comprises a propylene homopolymer or a copolymer of ethylene and propylene or ethylene and butylene or propylene and butylene or ethylene and another α-olefin having 5 to 10 carbon terpolymer of ethylene, propylene and another α-olefin having 5 to 10 carbon atoms, a mixture of two or more of said homopolymers, copolymers and terpolymers, and a blend of two or more of said homopolymers, copolymers and terpolymers that is optionally mixed with one or more of said homopolymers, copolymers and terpolymers, and wherein mixture component II is selected from one of an HDPE or a blend of two blend components A and B, in which blend component B includes a propylene homopolymer, a copolymer of ethylene and propylene, a copolymer of ethylene and butylene, a copolymer of propylene and butylene, a copolymer of ethylene and another α-olefin having 5 to 10 carbon atoms, a copolymer of propylene and another α-olefin having 5 to 10 carbon atoms, a terpolymer of ethylene, propylene and butylene, a terpolymer of ethylene, propylene and another α-olefin having 5 to 10 carbon atoms, a mixture of two or more of said homopolymers, copolymers and terpolymers, and a blend of two or more homopolymers, copolymers and terpolymers, and wherein the film has a silk-matt finish.

There is a commercial need therefore for a multilayer film that will mitigate or eliminate such processing liabilities, such as those discussed above.

### SUMMARY

We have discovered that a skin layer or layers, if extruded over a matte layer in a multilayer film, will reduce or eliminate the processing liabilities discussed above, while still maintaining a matte or a total film that has a high haze.

A matte film having a high haze, comprising a core layer selected from one of (iPP), high density polyethylene (HDPE), syndiotactic polypropylene (sPP), RCP, or linear low density polyethylene (LLDPE), the core layer having a first surface and a second surface, the core layer being present in the total film at a thickness in the range of from 5-500 μm, is contemplated. Additionally, at least a first matte layer contiguous to one of the first or the second surfaces of the core layer, the matte layer including a material selected from EP block copolymers, or blends of 2 or more materials selected from RCP, iPP, HDPE, EVA, EMA, EEA, EPB, or combinations thereof, the matte layer having a thickness in the range of from 0.5-8 μm. Further contemplated is at least a first skin layer contiguous to the matte layer, the matte layer spaced between the core layer and the skin layer, the skin layer including materials selected from one of iPP, RCP, PB, EPB, HDPE, LLDPE, MDPE, EVA or combinations thereof, the combinations thereof, when present, being combinations of compatible polymers, wherein the skin layer is present in the film in the range of from 0.1-3 μm.

These and other features, aspects and advantages of embodiments of our invention will become better understood with reference to the following description and appended claims.

### DETAILED DESCRIPTION

In certain embodiments of our invention, multilayer matte films are contemplated. The matte layer or layers will generally be beneath a skin layer or layers. These multilayer matte films will exhibit a superior processability as well as excellent matte characteristics, as compared to multilayer matte films without a skin layer or layers.

The combination of matte look and good processability will be especially useful in packaging, labeling and image films.

Following is a detailed description of certain combinations of multilayer matte film with a skin layer or layers, their fabrication into useful articles and use of these articles. Those skilled in the art will appreciate that numerous modifications to these embodiments may be made without departing from the scope of our invention. For example, while certain specific multilayer matte films are exemplified, other multilayer matte films are also contemplated. Additionally, while packaging, labeling and imaging are discussed as among the uses for the embodiments of our invention, other uses are also contemplated.

To the extent that this description is specific, it is solely for the purpose of illustrating certain embodiments of the invention and should not be taken as limiting the present inventive concepts to these specific embodiments.

Embodiments of our invention include a matte surface film, including: (a) a core layer of a thermoplastic polymer, the core layer having a first surface and a second surface, (b) at least one matte layer on at least a first surface of the core layer, the matte layer may include a single polymer or a blend of (I) at least one of (1) a copolymer of ethylene and propylene or (2) a terpolymer of ethylene, propylene and a C₄ to C₁₀ alpha-olefin or (3) propylene homopolymer; and (ii) an ethylene polymer, and c) a skin layer or layers.

### Core Layer

The core layer of embodiments of our invention may include a material selected from one of isotactic polypropylene (iPP) homopolymer, ethylene propylene random copolymer (RCP), high density polyethylene (HDPE), linear low density polyethylene (LLDPE), or syndiotactic polypropylene (sPP). Any of these materials, or those of other layers, may be Ziegler-Natta catalyst or metallocene catalyst produced, or combinations thereof. The core layer will generally have two surfaces, a first and a second surface.

Polypropylene copolymers, if used in the core layer may include one or more comonomers selected from one or more of ethylene or butene. The propylene will be present in such co or terpolymers at >90 weight percent. Propylene polymers contemplated will generally have a melting point ≧140° C., or ≧150° C. Examples of propylene polymers include but are not limited to, Fina 3371 (commercially available from Fina Oil and Chemical Company), or P 4252 (commercially available from Exxon Corp.). Syndiotactic polypropylene may possess an isotacticity of less than 25%, or less than 15%, or less than 6%. The mean length of the syndiotactic sequences may be greater than 20, or greater than 25. Syndiotactic polypropylene resins suited to use in the embodiments of our invention include, but are not limited to, EOD 93-06 or EOD 95-01, available from Fina Oil and Chemical Company.

Melt flow ratios (MFRs) of the polypropylenes may range from 0.5-8, or 1.5-5 g/10 min. Melt indices of the ethylene based polymers may range from 0.5-15 g/10 min.

Useful ethylene polymers include, but are not limited to HDPE M-6211 or HDPE M-6030 from Equistar Chemical Company, or HD-6704.67 from ExxonMobil Chemical Co.

The core layer of embodiments of our invention will have a thickness in the range of from 5-50 μm, or 5-200 μm, or 5-500 μm.

The core layer may contain microscopic voids and/or 1-15, or 1-8 or 2-4 weight % of an opacifying agent, based on the total weight % of the core layer, selected from one of iron oxide, carbon black, aluminum, TiO₂, talc, or combinations thereof.

Void-initiating particles which may be added as filler to the polymer matrix material of the core layer, can be any suitable organic or inorganic material which is incompatible with the core material at the temperature of biaxial orientation, such as polybutylene teraphthalate (PBT), nylon, solid or hollow preformed glass spheres, metal beads or spheres, ceramic spheres, calcium carbonate, or combinations thereof. Such materials may be present in the core layer at <30, or <20 or in the range of from 2-10 weight percent, based on the total weight of the core layer.

The average diameter of the void-initiating particles may be from 0.1-10 μm. These particles may be of any desired shape or they may be substantially spherical in shape. This does not mean that every void is the same size. It means that generally each void tends to be of like shape when like particles are used even though they vary in dimensions. These voids may assume a shape defined by two opposed and edge contacting concave disks.

The two average major void dimensions are greater than 30 microns.

The void-initiating particle material, as indicated above, may be incompatible with the core material, at least at the temperature of biaxial orientation.

The core may be described as being a thermoplastic polymer matrix material within which is located a strata of voids. The voids create the matrix configuration. The term “strata” is intended to convey that there are many voids creating the matrix and the voids themselves may be oriented so that the two major dimensions are aligned in correspondence with the direction of orientation of the polymeric film structure. As described herein above, iron oxide in an amount of from 1-8% by wt., or 2% -4% and aluminum in an amount of from 0-1.0% by wt., or 0.25% -0.85% may be added to the core matrix. Carbon black may also be used in lieu of some or all of the iron oxide.

A typical void of the core is defined as having major dimensions X and Y and minor dimensions Z, where dimension X is aligned with machine direction orientation, dimension Y is aligned with transverse direction orientation and dimension Z approximately corresponds to the cross-sectional dimension of the spherical particle which initiated the void.

Orientation conditions may be such that the X and Y dimensions of the voids of the core by major dimensions in comparison to the Z dimension. Thus, while the Z dimension generally approximates the cross-sectional dimension of the spherical particle initiating the void, X and Y dimensions may be significantly greater.

Polypropylene as a part of multilayer films, may be oriented at a temperature higher than its glass transition temperature. The temperature conditions may permit X and Y to be at least several multiples of the Z dimension without void splitting. As indicated above, the matrix polymer and the void initiating particle may be incompatible and this term is used in the sense that the materials are two distinct phases. The spherical void initiating particles constitute a dispersed phase throughout the lower melting polymer which polymer will, ultimately, upon orientation, become a void-filled matrix with the spherical particles positioned somewhere in the voids.

The core layer may contain hydrocarbon wax, which may be either a mineral wax or a synthetic wax. Polyethylene type wax may have an average chain length between 22-65 carbon atoms, or between 22-40 carbon atoms, a molecular weight between 300-800, and a melting point between about 125° F.-190° F. (52° C.-88° C.). These waxes may include paraffin waxes, microcrystalline waxes, and intermediate waxes length, a molecular weight between 300-450, and a melting point between about 125° F.-160° F. (52° C.-71° C.). The paraffin waxes typically include a mixture of normal and branched paraffins, with the normal paraffin content generally being from 35-90 percent by weight. The paraffin wax typically has a broad molecular weight distribution. For example, each fraction of chains containing a certain number of carbon atoms represents less than 25 percent, or less than 20 percent, of the wax. A paraffin wax having a broad molecular weight distribution provides better barrier properties than a paraffin wax having a narrow molecular weight distribution. A suitable wax is Chevron 143. It has a melting point of 143° F. (62° C.), an average chain length of 29 carbon atoms, an average molecular weight of 416, a normal paraffin content of 74 percent, and contains 12 percent C 28 fraction, 12 percent C 29 fraction, and 11 percent C 30 fraction (the three largest fractions in the wax). Typically, the core layer contains >10 wt % wax, or >12 wt % wax, or >15 wt % wax.

The core layer may also contain a hydrocarbon resin. Examples of such hydrocarbon resins may be found in U.S. Pat. No. 5,667,902, incorporated herein by reference. The resin may be a low molecular weight hydrocarbon which is compatible with the core polymer. The resin may, optionally, be hydrogenated. The resin may have a number average molecular weight <5000, or <2000, or in the range of from 500-1000. The resin can be natural or synthetic and may have a softening point in the range of from 60° C.-180° C. examples of hydrocarbon resins include, but are not limited to petroleum resins, terpene resins, styrene resins and cyclopentadiene resins.

Examples of commercially available hydrogenated resins are those including Piccolyte®, Regalrez®, Regalite®, available from Hercules Corp., and Escorez®, available from ExxonMobil Chemical Co.

One particular resin may be referred to as a saturated alicyclic resin. Such resins, if used, may have a softening point in the range of from 85° C.-140° C., or 100° C.-140° C., as measured by the ring and ball technique. Examples of commercially available saturated alicyclic resins are Arkon-P®, available from Arakawa Forest Chemical Industries, Ltd., of Japan.

The core layer may contain <15%, or <10% by weight of any such resins described above, singly or in any combination or in the range of from 2-10% by weight, or in some cases a different level 1-5% by weight, or 6-12% by weight.

Additionally, the core layer may contain more than one of the ingredients discussed above.

### Matte Layer

The matte layer or layers of embodiments of our invention will generally be contiguous to one or optionally both surfaces of the core layer. The matte layers, if two are present, may be the same or different in their polymer makeup. Materials useful in the matte layer include, but are not limited to ethylene propylene block copolymers (EP block) or blends of incompatible polymers such as ethylene propylene random copolymers (RCP), polypropylene homopolymers (PP), high density polyethylene (HDPE), ethylene vinyl acetate (EVA), ethylene methyl acrylate (EMA), ethylene ethyl acrylate (EEA), or ethylene propylene butene terpolymers (EPB), propylene butene copolymer (PB), or combinations thereof.

Generally, matte appearance may be achieved, in addition to a single polymer with the desired properties, when two or more blending partners are somewhat immiscible. Generally, at least one propylene based polymer will be blended with one or more ethylene based polymers. The matte layer may have a thickness in the range of from 0.5-8 μm, or 1-5 μm, or 1-4 μm, or 1-3 μm. If there are 2 or more matte layers, they may be the same or different in thickness.

A matte finish can be described as relatively high haze and/or as relatively low gloss. Haze is measured by ASTM D-1003 and will be in the range of from 20-80%, or 40-80%, or 50-80%, or 55-80%, or 60-80%. Gloss is measured by ASTM-D-523 at an angle of 85° and will have values for embodiments of our invention in the range of from 5-40, or 5-25, or 5-20, or 5-15. Values for these parameters of embodiments of our invention may be alternative or conjunctive.

The matte resins can be blends of high density polyethylene resins with a predominately propylene based polymer (homopolymer, copolymer or terpolymer).

The quality of the matte surface can be affected by the choice of polymers in the ethylene polymer and propylene polymer phases. A lower gloss, higher haze surface can be created by reducing the molecular weight of the polypropylene phase.

Embodiments of our invention may include blending a low molecular weight copolymer and/or terpolymer with a high molecular weight copolymer and/or terpolymer in the matte layer.

The matte layer may be formed by providing a blend of at least one high molecular weight, phase-separating component, and at least one low molecular weight phase-separating component, with high molecular weight high density polyethylene (HMW HDPE). Examples of suitable high molecular weight copolymers and or terpolymers include, but are not limited to, copolymers and terpolymers having a melt flow rate (MFR) of equal to or less than 8 dg/min., as measured by ASTM D 1236 at 230° C., such as Chisso XPM 7700 or Chisso XPM 7800 series propylene terpolymers.

Examples of suitable low molecular weight copolymers and/or terpolymers include copolymers and terpolymers having a MFR of equal to or greater than 10 dg/min, includes a copolymer such as HF3193 propylene terpolymer. (available from Chisso Corp.)

The ratio of high molecular weight copolymer and/or terpolymer to low molecular weight copolymer and/or terpolymer, may be in the range of from 25:75 to 75:25, or 50:50 high molecular weight component to low molecular component.

High molecular weight high density polyethylene (HMWHD) polymers may have a melt index of less than 1 or less than 0.5. The HMWHD PE may have a density of 0.940-0.970 g/cm³, and a melting point of 115° C.-140° C. For example, the HMW HDPE may have a density of 0.95-0.970 g/cm³, and a melting point of 120° C.-134° C. Melt index may be measured in accordance with ASTM D1238, under a load of 2.16 kg at 190° C.

A matte layer may contain very small (e.g. microscopic) raised areas in the form of fibers (e.g. elongated ridges) and/or in the form of nodules (e.g. essentially spherically shaped mounds). Those surfaces, which include primarily fibers, may be described as fibrillar, whereas those including primarily nodules, maybe described as nodular.

The HDPE portion of the matte film may be blended as well. Ethylene vinyl acetate (EVA) copolymer may also be used.

The copolymer of ethylene and propylene and the terpolymer of ethylene, propylene and butylene may include predominantly propylene. Such copolymer or terpolymer, may contain more than 80% propylene. The ethylene polymer may include a copolymer or a blend of different kinds of ethylene polymers. For example, the ethylene polymer may be a blend of two or more ethylene polymers each having different densities. In one embodiment, the ethylene polymer comprises at least a first ethylene polymer having a density of at least 0.91 g/cm³ and a second ethylene polymer having a density, which is different from the density of the first ethylene polymer. For example, the blend may comprise of high density polyethylene and low density polyethylene, or linear low density polyethylene. The ratio of the blend components may vary depending upon the polyethylene components of the blend and the desired characteristics of the layer. A blend, in which an equal proportion of each component is employed, such as a 50:50 blend, may be used. However, other blends may be used, such as a blend of 50% ethylene-propylene-butene-1 terpolymer, 40% high density polyethylene (0.95 g/ g/cm³), and 10% of a lower density polyethylene (0.92 g/cm³ or less).

Commercially available polymer products which may be used to form the matte layer include, but are not limited to, the following: EP 8573, which is an ethylene propylene copolymer, sold by Fina Oil and Chemical Company; Chisso 7800, which is an ethylene butylene propylene terpolymer, sold by Chisso Corporation; Fina EOD 97-09, which is metallocene catalyzed isotactic polypropylene (m-iPP), sold by Fina Oil and Chemical Company; Fina EOD 98-03, which is metallocene catalyzed syndiotactic polypropylene (m-sPP), sold by Fina Oil and Chemical Company; Equistar M6211, which is a high density high molecular weight polyethylene resin from Equistar Corporation; Mobil HXZ 801 HDPE resin from ExxonMobil Chemical Company; and Equistar L5005 HDPE polyethylene resin from Equistar Company.

Also contemplated are additional layers spaced between the core layer and one or more layers on the surface or surfaces of the core layer. Such additional layers may be made up of one or more polymers from any of those polymers described herein.

### Skin Layers

One or more skin layers will be contiguous to the matte layer or layers in embodiments of our invention. The skin layer or layers may include, but are not limited to, materials selected from one of isotactic polypropylene (iPP), polypropylene random copolymer (RCP), propylene butene copolymer (PB), ethylene propylene butene terpolymer (EPB), HDPE, EVA copolymer, linear low density polyethylene (LLDPE), medium density polyethylene (MDPE), or combinations thereof, as long as such combinations do not include those combinations that result in an incompatible or immiscible blend, such as those that might be employed in the matte layer. The skin layer or layer may be present in the film in the range (each, if there is more than one) of from 0.1-3 μm, or 0.3-2 μm, 0.3-1.5 μm, or 0.5-2 μm, or 0.3-1 μm. A second skin layer may optionally be contiguous to a second surface of the core layer or a second skin layer may optionally be contiguous to a second matte layer, and will be chosen from the above list of possible polymers or polymer combinations. The first skin layer, contiguous to the matte layer, and the second skin layer, if present, may be the same or different in either its polymer makeup and/or thickness.

The skin layers will generally be free of the elements that contribute to the haze of the matte layers. By substantially free from, we intend that substantially no polymers that raise haze values of the one or more skin layers will be present. By substantially free, we intend <10%, or <5%, or <1%, or <0.1% by weight of any such polymer combination or additive. The skin layers may however, contain anti-oxidants, anti-ozonants, anti-stats, antiblocks and the like.

### Coating

One or more coatings may be applied to one or more outermost surfaces of the multilayer film. Conventional coating techniques are contemplated. Polymers for coating may be selected from acrylic, polyvinylidene chloride (PVDC), polyvinyl alcohol (PVOH), ethylene acrylic acid copolymer (EAA), ethylene methyl acrylate copolymer (EMA) or combinations thereof.

Acrylic coatings can be derived from any of the terpolymeric compositions disclosed in U.S. Pat. Nos. 3,753,769, and 4,865,908, the contents of which are incorporated by reference herein. These coating compositions contain, as a film forming component, a resin including an interpolymer of (a) from 2 to 15, or from 2.5 to 6, parts by weight of an alpha-beta monoethylenically unsaturated carboxylic acid selected including one or more of acrylic acid, methacrylic acid, or mixtures thereof, and (b) from 85 to 98, or from 94 to 97.5, parts by weight of neutral monomer esters, the neutral monomer esters including (1) methyl acrylate or ethyl acrylate and (2) methyl methacrylate. These interpolymer compositions are further characterized by including from 30 percent to 55 percent by weight of methyl methacrylate when the alkyl acrylate is methyl acrylate, and from 52.5 percent to 69 percent by weight of methylmethacrylate when the alkyl acrylate is ethyl acrylate. Such coating compositions can be applied to the films herein in a variety of ways including in the form of ammoniacal solutions.

Similarly useful are copolymeric coating compositions prepared from the foregoing neutral monomer esters. These coating compositions may be applied to the multilayer film in the form of emulsions.

The coating can also be based on any of the known and conventional polyvinylidene chloride (PVDC) compositions heretofore employed as coatings in film manufacturing operations, e.g., any of the PVDC materials described in U.S. Pat. Nos. 4,214,039; 4,447,494; 4,961,992; 5,019,447; and 5,057,177.

U.S. Pat. No. 5,230,963 discloses enhancing oxygen barrier of films by a method involving a coating, which is incorporated herein by reference, or with prior application of a primer layer, to enhance adhesion of the PVDC coating layer to the film surface to which it is applied. Commercially available PVDC latexes having a vinylidene chloride content of at least 50%, or from 75% -92% may be employed. The PVDC can also be provided as a copolymer of vinylidenechloride and one or more other ethylenically unsaturated comonomers including alpha, beta ethylenically unsaturated acids such as acrylic and methacrylic acids; alkyl esters containing 1-18 carbon atoms of acids, such as methylmethacrylate, ethyl acrylate, butyl acrylate, etc. In addition alpha, beta ethylenically unsaturated nitrites such as acrylonitrile and methacrylonitrile and monovinyl aromatic compounds such as styrene and vinyl chloride comonomers can be employed. Specific PVDC latexes contemplated include: 82% by weight vinylidene chloride, 14% by weight ethyl acrylate and 4% by weight acrylic acid. Alternatively a polymer latex including 80% by weight vinylidene chloride, 17% methyl acrylate and 3% by weight methacrylic acid can likewise be employed.

The vinyl alcohol polymers, which may be used as coatings, can be any commercially available materials. For example, Vinol 125, 99.3+% super hydrolyzed polyvinyl alcohol, or VINOL 325, 98% hydrolyzed polyvinyl alcohol obtained from Air Products, Inc. Application of a PVOH coating is further described in U.S. Pat. No. 5,230,963, incorporated herein by reference.

Before applying the coating composition to the appropriate substrate, the upper surface of the film may be treated as noted herein to increase its surface energy and therefor insure that the coating layer will be strongly adherent thereto thereby reducing the possibility of the coating peeling or being stripped from the film. This treatment can be accomplished employing known techniques, such as, for example, film chlorination, i.e., exposure of the film surface to gaseous chlorine, treatment with oxidizing agents such as chromic acid, hot air or steam treatment, flame treatment, or exposing the film surface to a high voltage corona discharge while passing the film between a pair of spaced electrodes and the like. After treatment of the film surface, the coating composition is then applied thereto.

In applications where even greater coating-to-film adherence is desired, greater than that resulting from treatment of the film surface by any of the aforediscussed methods, an intermediate primer coating can be employed to increase the adherence of the coating composition to the film. In this case, the film may be first treated by one of the foregoing methods to provide increased active adhesive sites thereon (thereby promoting primer adhesion) and to the thus treated film surface there may be subsequently applied a continuous coating of a primer material. Such primer materials are well known in the prior art and include, for example, epoxy and poly(ethylene imine) (PEI) materials. U.S. Pat. Nos. 3,753,769 to Steiner, 4,058,645 to Steiner and 4,439,493 to Hein et al., incorporated herein by reference, disclose the use and application of such primers. The primer can be applied to the film by conventional solution coating means, for example, by mating roller application.

The coating composition can be applied to the film as a solution, one prepared with an organic solvent such as an alcohol, ketone, ester, and the like. However, since the coating composition can contain insoluble, finely divided inorganic materials which may be difficult to keep well dispersed in organic solvents, the coating composition may be applied to the treated surface in any convenient manner, such as by gravure coating, roll coating, dipping, spraying, and the like. The excess aqueous solution can be removed by squeeze rolls, doctor knives, and the like.

The film can be stretched in the machine direction, coated with the coating composition and then stretched perpendicularly in the transverse direction. In yet another embodiment, the coating can be carried out after biaxial orientation is completed.

The coating composition may be applied in such amount that there will be deposited upon drying a smooth, evenly distributed layer, generally on the order of from 0.01-0.2 mil thickness (0.25-5 μm) (equivalent to 0.2-3.5 g per 1000 sq. in. of film). Generally, the coating comprises 1-25 wt %, or 7-15 wt % of the total coated film composition. The coating on the film may subsequently be dried by hot air, radiant heat or by any other convenient means.

### Metallization

Generally one of the skin layers will be a layer that may be metallized. However, if no skin layer is utilized, a core layer surface may be metallized. Such metallization may include vacuum metallization through deposition of aluminum. Metallization and coating discussed above will generally be applied to which ever outermost surface of the film that is treated. Metallization or coating may be applied alone or in some cases together. When they are applied together, either may be applied first, followed by the other.

### Orientation

In embodiments of our invention, the multilayer matte film may be oriented, either uniaxially or biaxially. Orientation will generally be referred to in relation to the direction of extrusion, “machine direction” or MD, will be in direction of extrusion, while “transverse direction” or TD will generally be perpendicular to the extrusion direction. Such orientation may be accomplished in blown film by controlling such parameters as take up and blow up ratio. Orientation may also occur in cast films, with MD orientation which may be accomplished by take up speed, and TD through the use of tenter equipment, generally subsequent to extrusion. Orientation ratios may generally be in the range of 1:1-1:15, or MD 1:4-1:10 or in TD 1:7-1:12.

### Treating

One or more of the exposed or outer-most surfaces of the multi-layer films of embodiments of our invention can be surface-treated to render them receptive to metallization, coating, printing inks or lamination. The surface treatment can be carried out according to one of the methods known in the art. Methods which include, corona treatment, flame treatment, plasma, or treatment by means of a polarized flame. Generally the treated surface of films of embodiments of our invention will be treated on the outermost surface of the composite film that is opposite the matte layer. If there are two matte layers, one surface will generally be treated.

### Other Ingredients

Other ingredients in our inventive blends include, but are not limited to, pigments, colorants, antioxidants, antiozonants, antifogs, antistats, fillers such as calcium carbonate, diatomaceous earth, carbon black, combinations thereof, and the like. Such additives may be used in effective amounts, which vary depending upon the property required, and are, typically selected from one or more of antiblock, slip additive, antioxidant additive, moisture barrier additive or gas barrier additive.

Useful antistatic additives, which can be used in amounts ranging from 0.05 to about 3 weight %, based upon the weight of the layer, include alkali metal sulfonates, polyether-modified polydiorganosiloxanes, polyalkylphenylsiloxanes and tertiary amines.

Useful antiblock additives used in amounts ranging from 0.1 weight %-3 weight % based upon the entire weight of the layer include inorganic particulates such as silicon dioxide, e.g. a particulate antiblock sold by W. R. Grace under the trademark “Sylobloc 44”, calcium carbonate, magnesium silicate, aluminum silicate, calcium phosphate, and the like, e.g., Kaopolite®. Another useful particulate antiblock agent is referred to as a non-meltable crosslinked silicone resin powder sold under the trademark “Tospearl” made by Toshiba Silicone Co., Ltd. And is described in U.S. Pat. No. 4,769,418. Another useful antiblock additive is a spherical particle made from methyl methacrylate resin having an average diameter of 1-15 microns, such an additive is sold under the trademark “Epostar” and is commercially available from Nippon Shokubai.

Typical slip additives include higher aliphatic acid amides, higher aliphatic acid esters, waxes and metal soaps which can be used in amounts ranging from 0.1-2 weight percent based on the total weight of the layer. An example of a useful fatty amide slip additive is erucamide.

A conventional silicone oil or gum additive having a viscosity of 10,000-2,000,000 cSt. Is also contemplated.

Useful antioxidants are, generally used in amounts ranging from 0.1 weight %-2 weight percent, based on the total weight of the layer, phenolic anti-oxidants. One useful antioxidant is commercially available under the trademark “Irganox 1010” (Ciba-Geigy).

Barrier additives are used in useful amounts and may include low-molecular weight resins, hydrocarbon resins, particularly petroleum resins, styrene resins, cyclopentadiene resins and terpene resins.

Optionally, the skin layers may be compounded with a wax for lubricity. Amounts of wax range from 2-15 weight % based on the total weight of the layer. Any conventional wax useful in thermoplastic films is contemplated.

### Process of Making the Film

Typically, the matte surface film may be formed by coextruding the thermoplastic polymer core layer together with the matte surface layer and any additional layers through a flat sheet extruder die at a temperature ranging from between 200° C.-250° C., casting the film onto a cooling drum and quenching the film. The sheet is then stretched 3-7 times its original size, in the machine direction (MD) orienter, followed by stretching 5-10 times its original size in the transverse direction (TD) orienter. The film is then wound onto a reel. Optionally, one or both of the external surfaces may be coated and/or flame treated or corona treated before winding.

In general, the film of embodiments of our invention comprises at least three layers: the core layer and the matte layer, and a skin layer contiguous to the matte layer. We contemplate that additional layers can be incorporated between the core layer and the outermost skin layer or layers, e.g., tie layers comprising polypropylene, polyethylene or combinations thereof. The core layer may represent 40-90 percent of the thickness of the total film.

The film may be used as packaging, labeling, or imaging film. The film may be printed by any conventional means, contemplated printing means include letterpress, offset, silk screen, electrostatic and photographic methods. Specific printing methods contemplated include thermal dye transfer (including dye sublimation), lithographic printing, flexographic printing, gravure printing, hot stamping, valley printing, roll-leaf printing and spanishing. Polyolefins are normally treated before printing in order to make them receptive to inks. Treating methods include casing, electronic treating and flame treating.

Definitions and Testing Protocols

| | |
|---|---|
| Melt Flow Rate (MFR): | ASTM D 1238, condition L |
| Melt Index (MI): | ASTM D 1238, condition E |
| Haze (%) | ASTM D 1003 |
| Gloss | ASTM D 523 |

Experimental

| | |
|---|---|
| Materials: | |
| Chisso XPM 7791 | available from Chisso Corp. |
| Chisso HF3140A | available from Chisso Corp. |
| Fina 3371 | available from Fina Oil & Chemical |

### Matte Type Film Structures

The matte layer may be encapsulated in a 4 layer film structure. Once buried under an outside skin layer of PP, EP, PB, EPB or PE-type resin, the resulting film has a matte appearance (low gloss, high haze). This multilayered film structure enables the same matte film properties to be achieved as a three-layer structure, while improving the processability of the film in particular die lip build-up and issues associated with it are reduced on biaxially oriented polypropylene (BOPP) manufacturing lines, utilizing embodiments of our invention.

### Pilot Line Run

The film structure produced on the pilot is shown below:

Treated
EPB terpolymer (Chisso XPM 7791)
PP/PE Blended matte type polyolefin resin (Chisso HF3140A)
Isotactic PP homopolymer
PP/PE Blended matte type polyolefin resin (Chisso HF3140A)
EPB terpolymer (Chisso XPM 7791)

The matte appearance of the film changes depending on the thickness of both of the outside skin and the matte tie layer. As the matte tie layer increases in thickness, the haze generally becomes higher and the gloss generally lower. The matte produces produced may be two side sealable. The results are shown in the table below:

| Outside Skin | Matte Tie Layer | | |
|---|---|---|---|
| rpms | rpms | Haze | Gloss |
| 30 | 30 | 60% | 19 |
| 18 | 39 | 72% | 8 |
| 20 | 42 | 75% | 7 |

| | | |
|---|---|---|
| Control Matte Film* | 68% | 10 |

*The Control Matte Film will have a general structure:

The matte appearance of the film changes depending on the thickness of both of the outside skim and the matte tie layer. As the matte tie layer increases in thickness, the haze generallu becomes higher and the gloss generally lower. The matte films produced may be two side sealable. The results are shown in the table below:

PP/PE Blended matte type polyolefin resin (Chisso HF3140A)
Isotactic PP homopolymer
Isotactic PP homopolymer

### Semiworks Line Run

The film structure produced on the semiworks line is shown below:

Treated
EPB terpolymer or homopolymer PP
PP/PE Blended matte type polyolefin resin (Chisso HF3140A)
Isotactic PP homopolymer
Isotactic PP homopolymer
EPB terpolymer

As seen in the semi-works line trial, the matte appearance of the film changes depending on the thickness of both of the outside skin and the matte tie layer. As the matte tie layer increases in thickness, the haze becomes generally higher and the gloss, generally lower. However, the haze level reaches a maximum plateau, which can only be overcome by reducing the outside skin thickness. Again matte films with two skins of EPB terpolymer are two side sealable. The results are shown in the table below:

| Outside Skin | Matte Tie Layer | | |
|---|---|---|---|
| Approx. Thickness | Approx. Thickness | Haze | Gloss |
| 2.5 gauge | 5 gauge | 30% | 26 |
| 2.5 gauge | 10 gauge | 50% | 14 |
| 2.5 gauge | 15 gauge | 58% | 13 |
| 1.0 gauge | 20 gauge | 64% | 11 |

| | | |
|---|---|---|
| Control Matte Film (*) | 68% | 10 |

(1 mil = 25.4 μm = 100 gauge units)

Based on these results, it may be possible to reduce the matte tie layer thickness from 20 gauge back to 10-15 gauge when using a thinner 1.0 gauge outside skin thickness.

Although the present invention has been described in considerable detail with reference to certain embodiments thereof, other embodiments are possible. For example, while multilayer matte films are exemplified with one or more matte layers and one or more corresponding skin layers, other constructions are contemplated. Therefore, the spirit and scope of the appended claims should not be limited to the description of the embodiments contained herein.

1. A film including a matte layer covered with a skin layer, comprising:
a.) a core layer of isotactic polypropylene homopolymer (iPP), present in said film at a thickness in the range of from 5-50 μm, said core layer having a first and second surface;
b.) a first matte layer, said first matte layer being present in said film at a thickness in the range of from 1-3 μm, said first matte layer being contiguous to said first surface of said core layer, said first matte layer including one of:
i) an ethylene propylene block copolymer(EP);
ii) a blend of one or more of ethylene propylene random copolymer (RCP), isotactic polypropylene homopolymer (iPP), ethylene propylene butene terpolymer (EPB), or propylene butene copolymer (PB), and one or more of high density polyethylene (HDPE), ethylene vinyl acetate (EVA), ethylene methyl acrylate (EMA), or ethylene ethyl acrylate (EEA);
iii) a blend of high molecular weight (HMW) HDPE, a co or terpolymer of propylene having a MFR <8 dg/min., and a co or terpolymer of propylene having a MFR >10 dg/min.; or
iv) a blend of an EPB present in said blend in the range of from 40-60 wt %, HDPE present in said blend in the range of from 15-25 wt %, HMW HDPE present in said blend in the range of from 15-25 wt %, and EVA present in said blend in the range of from 5-15 wt %;
c.) a first skin layer being a material selected from one of EPB, iPP, RCP, PB, HDPE, linear low density polyethylene (LLDPE), medium density polyethylene (MDPE), or EVA, said first skin layer present in said film at a thickness in the range of from 0.3-1.5 μm, wherein said first matte layer is spaced between said core layer and said first skin layer;
d.) a second skin layer being a material selected from one of EPB, iPP, RCP, PB, HDPE, LLDPE, MDPE, or EVA, said second skin layer present in said film at a thickness in the range of from 0.5-2 μm, said second skin layer being contiguous to said second surface of said core layer;
wherein said first and said second skin layers may be the same thickness or different, wherein said first and said second skin layers may be the same material or different; and wherein said film has a haze in the range of from 40-80%, as determined by ASTM D-1003.

2. The film of claim 1 wherein said core layer further includes:
i) an opacifying agent selected from one of iron oxide, carbon black, aluminum, TiO₂, talc, or combinations thereof; said opacifying agent present in said core layer in the range of from 2-4 weight percent, based on the total weight of the core layer;
ii) a material selected from one of polybutene teraphthalate, nylon, solid glass spheres, hollow glass spheres, metal beads, metal spheres, ceramic spheres, CaCO₃ or combinations thereof, said material having a mean particle size in the range of from 0.1-10 μm, said material present in said core layer in the range of from 2-10 weight %, based on the total weight of the core layer;
iii) a hydrocarbon resin, said resin being one of petroleum resin, terpene resin, styrene resin, cyclopentadiene resin, saturated alicyclic resin, or combinations thereof, said resin has a number average molecular weight <5000, said resin has a softening point in the range of from 60° C.-180° C., said resin present in said core layer at <10 weight percent; or
iv) combinations thereof.

3. The film of claim 2, wherein said film is treated on at least one of said film's outermost surfaces.

4. The film of claim 3, wherein said treatment is selected from one of flame, plasma, or corona.

5. The film of claim 4, wherein said film is coated with said coating selected from one of, polyvinylidene chloride (PVDC), polyvinyl alcohol (PVOH), or combinations thereof, to a thickness in the range of from 0.2-5 μm.

6. The film of claim 4, wherein said film is metallized on one of said film's outermost surfaces by vacuum deposition of aluminum.

7. The film of claim 4, wherein said film is coated with said coating selected from one of, PVDC, PVOH, or combinations thereof, to a thickness in the range of from 0.2-5 μm and wherein said film is metallized on one of said film's outermost surfaces, said coating may be on the same outermost surface as the metallization or different.

8. The film of any of claims 1, 2, 3, 4, 5, 6, or 7, wherein said film is oriented.

9. The film of any of claims 1, 2, 3, 4, 5, 6, or 7, wherein said film is biaxially oriented.

10. A matte film, comprising:
a) a core layer selected from one of iPP, high density polyethylene (HDPE), syndiotactic polypropylene (sPP), RCP, or linear low density polyethylene (LLDPE), said core layer having a first surface and a second surface, said core layer being present in the total film at a thickness in the range of from 5-500 μm;
b) at least a first matte layer contiguous to one of said first or said second surfaces of said core layer, said matte layer including a material selected from EP block copolymers, or blends of 2 or more materials selected from RCP, iPP, HDPE, EVA, EMA, EEA, PB, EPB, said matte layer having a thickness in the range of from 0.5-8 μm; and
c) at least a first skin layer contiguous to said matte layer, said matte layer spaced between said core layer and said skin layer, said skin layer including materials selected from one of iPP, RCP, PB, EPB, HDPE, LLDPE, MDPE, EVA or combinations thereof, said combinations thereof, when present, being combinations of compatible polymers,
wherein said skin layer is present in said film in the range of from 0.1-3 μm.

11. The matte film of claim 10 wherein said core layer is iPP, present in said matte film at a thickness in the range of from 5-200 μm; said first matte layer has a thickness in the range of from 1-5 μm, and said skin layer having a thickness of 0.3-2 μm; wherein said first skin layer is one of EPB, RCP or PB.

12. The matte film of claim 11 wherein said:
a.) said core layer is present in said matte film in the range of from 5-50 μm;
b.) said first matte layer is present in said matte film in the range of from 1-3 μm; and
c.) said first skin layer is one of EPB, RCP or PB, present in said matte film at a thickness in the range of from 0.3-1 μm.

13. The matte film of claims 10, 11, or 12, wherein said first matte layer is a blend of EPB, present in the range of from 40-60%; HDPE, present in the range of from 15-25%; HMW HDPE, present in the range of from 15-25%; and EVA, present in the range of from 5-15%, by weight, based upon the total weight of said at least one matte layer, wherein said film has a haze in the range of from 50-80% as measured by ASTM D-1003.

14. The matte film of claim 13, wherein said core layer further includes one of:
a.) an opacifying agent selected from one of iron oxide, carbon black, aluminum, TiO₂, talc or combinations thereof, said opacifying agent being present in said core layer, said opacifying agent present in said core layer in the range of from 1-15 weight %, based on the total weight of the core layer;
b.) a void inducing material, selected from one of polybutene teraphthalate (PBT), nylon, solid glass spheres, hollow glass spheres, metal beads, metal spheres, ceramic spheres, CaCO₃, or combinations thereof, said void inducing material present in said core layer at <20 weight %, said void inducing material having a mean particle size in the range of from 0.1-10 μm;
c.) a hydrocarbon wax having a melting point in the range of from 52° C.-88° C. and a molecular weight in the range of from 300-800;
d.) a hydrocarbon resin, said resin being one of petroleum resin, terpene resin, styrene resin, cyclopentadiene resin, saturated alicyclic resin, or combinations thereof, said resin having a number average molecular weight <5000, said resin having a softening point in the range of from 60° C.-180° C., said resin present in said core layer at <15 weight percent; or
e.) combinations thereof;
wherein said matte film is biaxially oriented, wherein said matte film has a haze in the range of from 55-80%.

15. The matte film of claim 14, wherein said film is treated on an outermost surface of said matte film, said treatment being one of corona, flame or plasma.

16. The matte film of claim 15, wherein said film is coated on said treated outermost surface of said matte film, said coating selected from one of acrylic, polyvinylidene chloride (PVDC), polyvinyl alcohol (PVOH), ethylene acrylic acid copolymer (EAA), ethylene methyl acrylate copolymer (EMA) or combinations thereof, wherein said coating is present on said one or more outermost surface in the range of 0.2-5 μm.

17. The film of claim 15, wherein said film is metallized on said film's treated outermost surface by vacuum deposition of aluminum.

18. The film of claim 15, wherein said film is metallized on said film's treated outermost surface by vacuum deposition of aluminum and wherein said film is coated with said coating selected from one of acrylic, PVDC, PVOH, EAA, EMA or combinations thereof, to a thickness in the range of from 0.2-5 μm and wherein said film is coated on one of said film's outermost surfaces.

19. The matte film of claim 18, wherein said matte film further includes a second skin layer contiguous to said second surface of said core layer, said second skin layer being the same or different material as said first skin layer, and being the same or different in thickness than said first skin layer.

20. The matte film of claim 19, wherein said second skin layer is one of EPB, PB, iPP, RCP, HDPE or MDPE.

21. The matte film of claim 20, wherein said matte film further includes a second matte layer, spaced between said second surface of said core layer and said second skin layer, wherein said second matte layer is the same material or different from said first matte layer, wherein said second matte layer is the same thickness or different thickness than said first matte layer.

22. The matte film of claims 10, 11, or 12, wherein said film has a haze in the range of from 20-80% as measured by ASTM D-1003.

23. The matte film of claims 10, 11, or 12, wherein said film has a haze in the range of from 40-80% as measured by ASTM D-1003.

24. The matte film of claims 10, 11, or 12, wherein said film has a haze in the range of from 50-80% as measured by ASTM D-1003.

25. The matte film of claims 10, 11, or 12, wherein said film has a haze in the range of from 60-80% as measured by ASTM D-1003.

26. A process for producing the matte film of claims 10, 11, or 12, comprising:
a) coextruding at least 3 layers;
i) said core layer,
ii) said first matte layer; and
iii) said first skin layer contiguous to said matte layer.

27. Packaging, labeling, or imaging film including the film of claims 10, 11, or 12.

28. The matte film of claims 10, 11, or 12, wherein said film is oriented.

29. The matte film of claims 10, 11, or 12, wherein said film is biaxially oriented.

30. The process of claim 26, further comprising laminating said matte film in a film lamination.

31. A matte film, comprising:
a) a core layer of an iPP, having a first surface and a second surface, said core layer being present in the total film at a thickness in the range of from 5-50 μm;
b) a first matte layer contiguous to said first surface of said core layer, said matte layer including EPB in the range of from 40-60 percent, HDPE in the range of from 15-25%, high molecular weight HDPE (HMW HDPE) in the range of from 15-25%, and EVA in the range of from 5-15%, based on the total weight of the matte layer, said matte layer having a thickness in the range of from 1-4 μm.
c) a first skin layer contiguous to said matte layer, said skin layer being one of EPB, RCP, or PB, wherein said skin layer is present in said film in the range of from 0.3-1 μm; and
d) a second skin layer contiguous to a said second surface of said core layer, said second skin layer being one of EPB, RCP, PB, iPP, HDPE, MDPE, or combinations thereof, wherein said second skin layer is present in said film in the range of from 0.5-2 μm, wherein said first and said second skin layers are the same or different thickness;
wherein said film has a haze in the range of from 60-80% as measured by ASTM D-1003.

32. The matte film of claim 31, wherein said core layer, wherein said core layer further polybutene teraphthalate (PBT), said PBT present in said core layer in the range of from 2-10 weight %, said PBT having a mean particle size in the range of from 0.1-10 μm, based on the total weight of the core layer, wherein said matte film is biaxially oriented.

33. The matte film of claim 31 or 32, wherein said matte film is treated on an outermost surface of said matte film by a method selected from one of flame, corona, or plasma.

34. The matte film of claim 33, wherein said film, on the treated surface, which is the second skin layer, is metallized by vacuum deposition of aluminum, or wherein said film is coated on the treated surface of said matte film, said coating selected from one of, PVDC, PVOH, or combinations thereof, wherein said coating is present on said treated surface, in the range of 0.2-5 μm, or said matte film is metallized and coated, wherein.
